(19) United States
(12) Patent Application Publication
(10) Pub. No.: US 2010/0131628 A1
(43) Pub. Date: May 27, 2010

(54) MOBILE BASE STATION AND HARDWARE PLATFORM RECONFIGURING METHOD FOR THE SAME

(75) Inventors: Bong Guk YU, Daejeon (KR); Sang Chul OH, Daejeon (KR); Hong Soog KIM, Daejeon (KR); Dae Ho KIM, Daejeon (KR); Yeong Jin KIM, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/541,331

(22) Filed: Aug. 14, 2009

(30) Foreign Application Priority Data
Nov. 26, 2008 (KR) 10-2008-0118303

(51) Int. Cl. G06F 15/177; H04M 1/00; G06F 9/44

(52) U.S. Cl. 709/221; 455/561; 717/173

(57) ABSTRACT

Provided is a hardware platform reconfiguring method for a mobile base station. A control signal for controlling the download of a program is generated based on an SDR technique. A program is received from an external device. The program from the external device is downloaded to a hardware module of the mobile base station based on the SDR technique according to the control signal.

### CROSS-REFERENCE TO RELATED APPLICATIONS

This application claims priority under 35 U.S.C. §119 to Korean Patent Application No. 10-2008-0118303, filed on Nov. 26, 2008, in the Korean Intellectual Property Office, the disclosure of which is incorporated herein by reference in its entirety.

### TECHNICAL FIELD

The following disclosure relates to a mobile base station and a hardware platform reconfiguring method for the same, and in particular, to a mobile base station and a hardware platform reconfiguring method for the same, which download software based on a Software Defined Radio (SDR) technique.

### BACKGROUND

Existing mobile base station has supported a specific wireless access standard which is able to support only a limited service, but users now require large-scale services such as video service and other Internet services in addition to the already established audio service. However, it is difficult for providers to replace an existing system in all service regions with a new system capable of providing large-scale service accommodating a frequency bandwidth according to users' requirements. While researches on various technologies for reconfiguring mobile base stations with new systems using existing hardware have been conducted, there are still many limitations.

Since a related art mobile base station is configured with components and elements suitable for a specific standard based on the use of fixed hardware, it is radically impossible to reconfigure it with other systems. However, as it will be described below with reference to FIG. 1, the related art mobile base station reconfigures a Field Programmable Gate Array (FPGA) using a read only memory (ROM) booting scheme, and thus adds a new function to FPGA.

FIG. 1 is a block diagram of digital intermediate frequency (IF) transceiver of the related art mobile base station.

Referring to FIG. 1, the related art digital IF transceiver 100 includes a plurality of ROMs 110-1 to 110-n (n is a natural number larger than 1) storing programs and data, a switch 120 selectively providing a plurality of paths, and an FPGA 130 processing a digital IF signal.

The ROMs 110-1 to 110-n store the programs used to convert a radio frequency (RF) signal into an IF signal and the programs used to convert a baseband signal into an IF signal. The programs stored in the ROMs 110-1 to 110-n are selectively provided to the FPGA 130 through the switch 120, thereby reconfiguring the FPGA 130.

The switch 120 is manually switched by a user to connect the FPGA 130 to any one of the ROMS 110-1 to 110-n.

The FPGA 130 is a device processing the digital IF signal, and is connected to any one of the ROMs 110-1 to 110-n through the switch 120 to download a new program from the connected ROM.

Since the FPGA 130 is reconfigured using the ROM booting scheme by a user, service interruption due to the reconfiguration occurs for a long time, and the flexibility of reconfiguration is reduced by the number of ROMs and a physical space of the board.

### SUMMARY

In one general aspect, a mobile base station includes: a Software Definition Radio (SDR) base-station controller controlling a download of a program provided from an external device based on an SDR technique; and a hardware module downloading the program provided from the external device based on the SDR technique according to a control signal from the SDR base-station controller.

In another general aspect, a hardware platform reconfiguring method for a mobile base station includes: generating a control signal for controlling a download of a program based on a Software Definition Radio (SDR) technique; receiving a program from an external device; and downloading the program from the external device to a hardware module of the mobile base station based on the SDR technique according to the control signal.

Other features and aspects will be apparent from the following detailed description, the drawings, and the claims.

### BRIEF DESCRIPTION OF THE DRAWINGS

FIG. 1 is a block diagram of digital IF transceiver of a related art mobile base station.

FIG. 2 is a block diagram of a mobile base station according to an exemplary embodiment.

FIG. 3 is a block diagram of an SDR-based transceiving module for describing a hardware platform reconfiguring method for the mobile base station according to an exemplary embodiment.

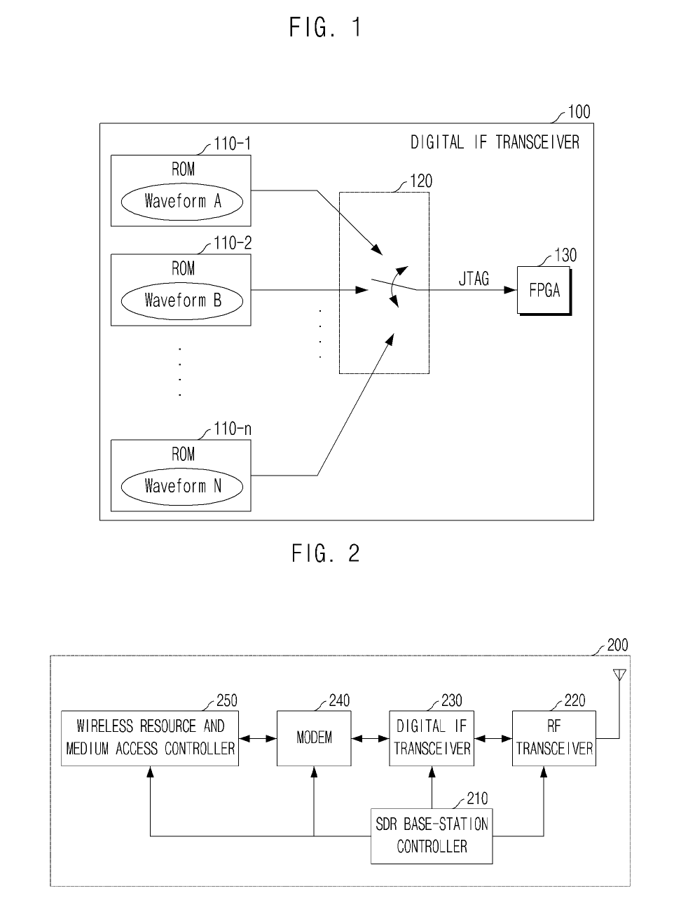

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/of systems described herein will be suggested to those of ordinary skill in the art. Also, descriptions of well-known functions and constructions may be omitted for increased clarity and conciseness.

FIG. 2 is a block diagram of a mobile base station according to an exemplary embodiment.

Referring to FIG. 2, the mobile base station 200 includes an SDR base-station controller 210 controlling the transceiving of a signal, an RF transceiver 220 transceiving an RF signal, a digital IF transceiver 230 processing an IF signal, a modem 240 modulating/demodulating a signal, and a wireless resource and medium access controller 250 controlling a wireless resource and a medium access.

The SDR base-station controller 210 controls the reception of an RF signal, IF modulation, demodulation of a signal, modulation of a signal and transmission of an RF signal. Particularly, the SDR base-station controller 210 controls the reconfiguration of the digital IF transceiver 230 and the reconfiguration of the modem 240 based on a SDR technique.

The RF transceiver 220 transfers an RF signal received through an antenna to the digital IF transceiver 230 according to the control of the SDR base-station controller 210. The RF transceiver 220 converts an IF signal outputted from the digital IF transceiver 230 into an RF signal to transmit through the antenna according to the control of the SDR base-station controller 210.

The digital IF transceiver 230 converts an RF signal transferred from the RF transceiver 220 into an IF signal to output to the modem 240, and converts a baseband signal outputted from the modem 240 into an IF signal to output to the RF transceiver 220, according to the control of the SDR base-station controller 210. The digital IF transceiver 230 is reconfigured by downloading new software provided from an external device according to the control of the SDR base-station controller 210.

The modem 240 demodulates an IF signal outputted from the digital IF transceiver 220 to output the demodulated baseband signal to the wireless resource and medium access controller 250 according to the control of the SDR base-station controller 210. The modem 240 also modulates a baseband signal outputted from the wireless resource and medium access controller 250 to output the modulated signal to the digital IF transceiver 230 according to the control of the SDR base-station controller 210. The modem 240 is reconfigured by downloading new software provided from the external device according to the control of the SDR base-station controller 210.

All the hardware modules of the mobile base station 200 have a communication function to support a middleware standard, and may be reconfigured according to a control signal from the SDR base-station controller 210. Herein, the hardware modules may be reconfigured with a High Speed Downlink Packet Access (HSDPA) system or the three profiles of an IEEE 802.16d WiMAX system, for example, a 7 MHz profile, a 3.5 MHz profile and a 1.75 MHz profile, according to a desired wireless access standard. Accordingly, all the hardware modules of the mobile base station 200 can be reused.

The above-described reconfiguration middleware layer provides the framework where the design pattern of internal system software including a device control program and an application is well used. Moreover, the middleware layer provides a flexible integrated environment between different kinds of hardware and software written with various programming languages. That is, all the software function modules of the mobile base station 200 are respectively defined as a device or a component based on the SDR technique, and the connections of the respective elements of the mobile base station 200 are respectively defined as an interface through a software bus. Since the SDR technique has real-time, flexibility, portability and reconfigurability, it is drawing much attention of international standard institutes such as 3GPP, IEEE, WiMAX Forum and SDR Forum, as the principal technique of a next generation mobile communication system.

As described above, an exemplary embodiment proposes a software download approach that installs a software layer, which is standardized by single board unit of the mobile base station 200, in a processor operating on hardware by function, thereby improving the easiness of reconfiguration.

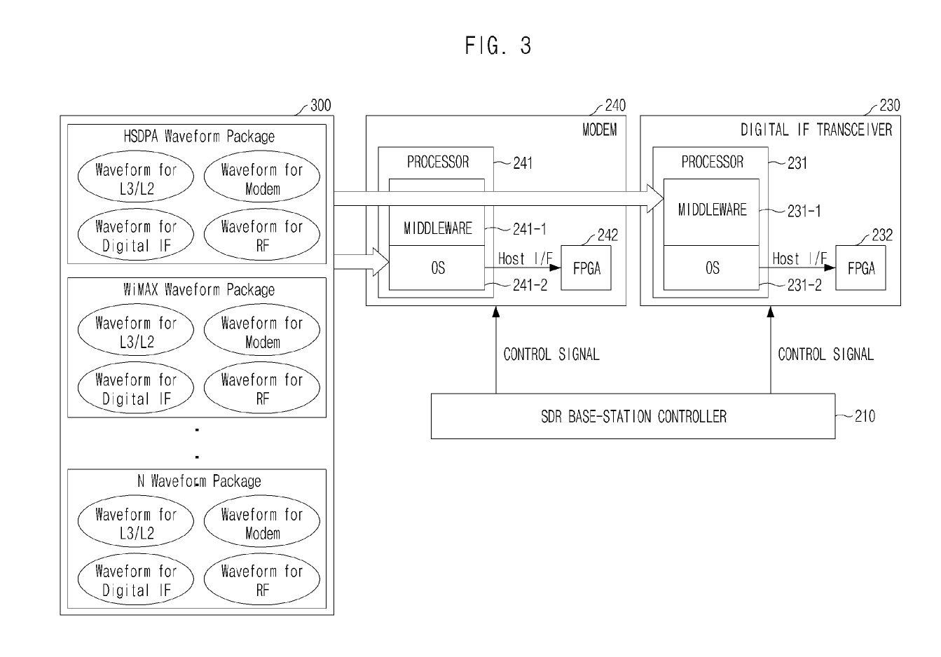

FIG. 3 is a block diagram of an SDR-based transceiving module for describing a hardware platform reconfiguring method for the mobile base station according to an exemplary embodiment.

Referring to FIG. 3, the digital IF transceiver 230 includes a processor 231 controlling the download of a program provided from an external device 300, and an FPGA 232 downloading the program provided through the processor 231 based on the SDR technique.

Herein, the external device 300 is a large-capacity memory, a large-capacity storage or an Internet server, which stores a plurality of standard programs and a plurality of new version programs. The external device 300 provides a stored program to the processor 231 upon a user's request.

The processor 231 downloads a program, which is provided from the external device 300, to the FPGA 232 based on the SDR technique according to the control signal from the SDR base-station controller 210. Herein, the control signal includes a download position of a program, authentication information and a communication system.

The processor 231 includes a middleware 231-1 and an operating system (OS) 231-2.

The middleware 231-1 provides a flexible integrated environment between different kinds of hardware and software written with various programming languages. That is, the middleware 231-1 provides a flexible integrated environment in order for a program from the external device 300 to be downloaded to the FPGA 232 through the OS 231-2.

The OS 231-2 downloads a program from the external device 300 to the FPGA 232 according to the control signal from the SDR base-station controller 210 in an integrated environment provided by the middleware 231-1. At this point, the OS 231-2 downloads the program from the external device 300 to the FPGA 232 through a host interface.

The FPGA 232 is a Digital Signal Processor (DSP) processing a digital signal, and downloads a new program through the processor 231 based on the SDR technique to be reconfigured.

The digital IF transceiver 240 includes a processor 241 controlling the download of a program provided from the external device 300, and a FPGA 242 downloading the program provided through the processor 241 based on the SDR technique.

Herein, the external device 300 is a large-capacity memory, a large-capacity storage or an Internet server, which stores a plurality of standard programs and a plurality of new version programs. The external device 300 provides a stored program to the processor 231 upon a user's request.

The processor 241 downloads a program, which is provided from the external device 300, to the FPGA 242 based on the SDR technique according to the control signal from the SDR base-station controller 210. Herein, the control signal includes a download position of a program, authentication information and a communication system.

The processor 241 includes a middleware 241-1 and an OS 241-2.

The middleware 241-1 provides a flexible integrated environment between different kinds of hardware and software written with various programming languages. That is, the middleware 241-1 provides a flexible integrated environment in order for a program from the external device 300 to be downloaded to the FPGA 242 through the OS 241-2.

The OS 241-2 downloads a program from the external device 300 to the FPGA 242 according to the control signal from the SDR base-station controller 210 in an integrated environment provided by the middleware 241-1. At this point, the OS 241-2 downloads the program from the external device 300 to the FPGA 242 through a host interface.

The FPGA 242 is a DSP processing a digital signal, and downloads a new program through the processor 241 based on the SDR technique to be reconfigured.

Particularly, the reconfiguration method of the mobile base station according to an exemplary embodiment uses an internal bus through an internal processor of each board, thereby reconfiguring the each hardware module at very high speed.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A mobile base station, comprising:
a Software Definition Radio (SDR) base-station controller controlling a download of a program provided from an external device based on an SDR technique; and
a hardware module downloading the program provided from the external device based on the SDR technique according to a control signal from the SDR base-station controller.

2. The mobile base station of claim 1, wherein the hardware module comprises:
a signal processor processing a digital signal; and
a processor downloading the program from the external device to the signal processor based on the SDR technique according to the control signal.

3. The mobile base station of claim 2, wherein the signal processor is a Field Programmable Gate Array (FPGA).

4. The mobile base station of claim 3, wherein the processor comprises:
a middleware providing a flexible integrated environment for the download of the program from the external device; and
an Operating System (OS) downloading the program from the external device to the FPGA according to the control signal in the integrated environment provided by the middleware.

5. The mobile base station of claim 4, wherein the OS downloads the program from the external device to the FPGA through a host interface.

6. The mobile base station of claim 1, wherein the hardware module is a digital Intermediate Frequency (IF) transceiver processing an IF signal.

7. The mobile base station of claim 1, wherein the hardware module is a modem modulating or demodulating a signal.

8. The mobile base station of claim 1, wherein the external device is a large-capacity storage storing a plurality of standard programs and a plurality of new version programs.

9. The mobile base station of claim 1, wherein the external device is an Internet server storing a plurality of standard programs and a plurality of new version programs.

10. The mobile base station of claim 1, wherein the control signal comprises a download position of a program, authentication information and a communication system.

11. A hardware platform reconfiguring method for a mobile base station, the hardware platform reconfiguring method comprises:
generating a control signal for controlling a download of a program based on a Software Definition Radio (SDR) technique;
receiving a program from an external device; and
downloading the program from the external device to a hardware module of the mobile base station based on the SDR technique according to the control signal.

12. The hardware platform reconfiguring method of claim 11, wherein the downloading of the program comprises:
providing a flexible integrated environment for the download of the program through a middleware; and
downloading, by an Operating System (OS), the program from the external device to a Field Programmable Gate Array (FPGA) according to the control signal in the integrated environment provided by the middleware.

13. The hardware platform reconfiguring method of claim 12, wherein the OS downloads the program from the external device to the FPGA through a host interface.

14. The hardware platform reconfiguring method of claim 11, wherein the control signal comprises a download position of a program, authentication information and a communication system.

15. The hardware platform reconfiguring method of claim 11, wherein the external device is a large-capacity storage storing a plurality of standard programs and a plurality of new version programs.

16. The hardware platform reconfiguring method of claim 11, wherein the external device is an Internet server storing a plurality of standard programs and a plurality of new version programs.
